(19) United States
(12) Patent Application Publication
(10) Pub. No.: US 2022/0278442 A1
(43) Pub. Date: Sep. 1, 2022

(54) ANTENNA, WIRELESS EARBUD AND ELECTRONIC DEVICE

(71) Applicant: GOERTEK TECHNOLOGY CO., LTD., Qingdao (CN)

(72) Inventors: Kenichiro Kodama, Qingdao (CN); Katsunori Ishimiya, Qingdao (CN)

(21) Appl. No.: 17/043,288

(22) PCT Filed: Nov. 22, 2019
(86) PCT No.: PCT/CN2019/120092

§ 371 Date: Sep. 29, 2020

(51) Int. Cl. H01Q 1/27; H01Q 1/48; H01Q 9/42

(52) U.S. Cl. CPC H01Q 1/273; H01Q 1/48; H01Q 9/42

(57) ABSTRACT

An antenna is provided. The antenna includes a metal plate, wherein the metal plate is at least a part of a housing of an earbud, the metal plate is configured to be electrically coupled to a feeding terminal and a grounding terminal on a PCB, and the PCB is accommodated in the earbud. The present disclosure further provides a wireless earbud including a housing, and a part of the housing constitutes an antenna component to act as an antenna radiator of the wireless earbud. The present disclosure further provides an electronic device including a housing, wherein the housing comprises a sole metal plate, and the sole metal plate constitutes an antenna component to act as an antenna radiator of the electronic device.

### TECHNICAL FIELD

The present disclosure generally relates to an antenna for a wireless earbud, a wireless earbud including the antenna, and an electronic device.

### BACKGROUND

Nowadays, earbuds, especially wireless earbuds, are necessary electronic accessories of mobile equipments. People pursue earbuds with high performance and high quality as well. Currently, most earbuds utilize plastic chassis as the shell of earbuds considering effects of metal on signal transmission. However, plastic chassis affects the rigidity of the shell of earbuds and looks low quality in appearance. It would therefore be desirable to provide a wireless earbud having high strength shell together with a high antenna performance.

### SUMMARY

According to embodiments of the present disclosure, an antenna is provided. The antenna includes: a metal plate, wherein the metal plate is at least a part of a housing of an earbud, the metal plate is configured to be electrically coupled to a feeding terminal and a grounding terminal on a PCB, and the PCB is accommodated in the earbud.

In some embodiment, the antenna further includes: a protection circuit, configured to be electrically coupled between the metal plate and the grounding terminal on the PCB; and a sole contact component, configured to be electrically coupled between the metal plate and the feeding terminal on the PCB.

In some embodiment, the protection circuit is an inductor or a resistor.

In some embodiment, the antenna further includes: a first contact component, configured to be electrically coupled between the metal plate and the feeding terminal, and a second contact component, configured to be electrically coupled between the metal plate and the grounding terminal.

In some embodiment, the first contact component and/or the second contact component is a pogo-pin or a leaf spring.

In some embodiment, the antenna further includes: a protection circuit, configured to be electrically coupled between the metal plate and the grounding terminal on the PCB; and a matching circuit, configured to be electrically coupled between the metal plate and the feeding terminal on the PCB, wherein the matching circuit and the protection circuit are electrically coupled to the metal plate through one contact point configured on the metal plate, or the matching circuit and the protection circuit are electrically coupled to the metal plate through two contact points configured on the metal plate respectively.

In some embodiment, the matching circuit includes an inductor, a capacitor or a resistor.

In some embodiment, the metal plate is made of aluminum or stainless steel.

In some embodiment, the metal plate takes a shape of a flat plate or a curved plate.

In some embodiment, the metal plate has a symmetrical structure relative to a center of the metal plate.

According to embodiments of the present disclosure, a wireless earbud is provided. The wireless earbud includes: a housing, and a PCB, accommodated in the housing and provided with a grounding terminal and a feeding terminal thereon, wherein a part of the housing constitutes an antenna component to act as an antenna radiator of the wireless earbud, the antenna component is electrically coupled to the feeding terminal on the PCB, and the antenna component is electrically coupled to the grounding terminal on the PCB.

In some embodiment, the wireless earbud further includes: a protection circuit, configured to be electrically coupled between the antenna component and the grounding terminal on the PCB; and a sole contact component, configured to be electrically coupled between the antenna component and the feeding terminal on the PCB.

In some embodiment, the protection circuit is an inductor or a resistor.

In some embodiment, the wireless earbud further includes: a first contact component, configured to be electrically coupled between the antenna component and the feeding terminal, and a second contact component, configured to be electrically coupled between the antenna component and the grounding terminal.

In some embodiment, the first contact component and/or the second contact component is a pogo-pin or a leaf spring.

In some embodiment, the wireless earbud further includes: a protection circuit, configured to be electrically coupled between the antenna component and the grounding terminal on the PCB; and a matching circuit, configured to be electrically coupled between the antenna component and the feeding terminal on the PCB, wherein the matching circuit and the protection circuit are electrically coupled to the antenna component through one contact point configured on the antenna component, or the matching circuit and the protection circuit are electrically coupled to the antenna component through two contact points configured on the antenna component respectively.

In some embodiment, the matching circuit includes an inductor, a capacitor or a resistor.

In some embodiment, the housing includes a top part farthest to a user in use and an in-ear part, and a first ring-shaped part and a second ring-shaped part connected in sequence between the top part and the in-ear part, wherein at least one of the top part, the first ring-shaped part and the second ring-shaped part constitutes the antenna component.

In some embodiment, the first ring-shaped part and/or the second ring-shaped part constitutes the antenna component, and the top part is made of a conductive material or plastic and is isolated from the antenna component.

In some embodiment, the antenna component is made of aluminum or stainless steel.

According to embodiments of the present disclosure, an electronic device is provided. The electronic device includes: a housing, and a PCB, accommodated in the housing and provided with a grounding terminal and a feeding terminal thereon, wherein the housing includes a sole metal plate, the sole metal plate constitutes an antenna component to act as an antenna radiator of the electronic device, the antenna component is electrically coupled to the feeding terminal on the PCB, and the antenna component is electrically coupled to the grounding terminal on the PCB.

Utilizing at least a part of the housing of the wireless earbud as an antenna radiator of the wireless earbud, the metal plate can be introduced onto the chassis of earbuds, and the rigidity of the shell and the appearance can be improved.

Further, it is convenient to conduct an industrial design of the antenna without slits on the shell of the earbuds. And the cost of the antenna can be decreased with decreased number of contact points and without additional antenna radiator. In addition, high antenna performance can be maintained by adjusting a matching circuit.

Further, the antenna is applicable to all wireless earbuds on the market due to similar size and shape of the wireless earbuds. Furthermore, the resonance frequency can be changed through adjusting the matching circuit according to different industry design of earbuds.

### BRIEF DESCRIPTION OF THE DRAWINGS

The above and other aspects, features, and advantages of the present disclosure will become more apparent from the following description, taken in conjunction with the accompanying drawings, in which:

FIG. 1 schematically illustrates a cross-sectional view of an internal structure of a wireless earbud according to an embodiment of the present disclosure;

FIG. 2 schematically illustrates an equivalent circuit diagram of an antenna of the wireless earbud according to an embodiment of the present disclosure;

FIG. 3 schematically illustrates an equivalent circuit diagram of an antenna of the wireless earbud according to another embodiment of the present disclosure;

FIG. 4 schematically illustrates an equivalent circuit diagram of an antenna of the wireless earbud according to yet another embodiment of the present disclosure;

FIG. 5 schematically illustrates a structure of a housing of a wireless earbud according to an embodiment of the present disclosure;

FIGS. 6A to 6D schematically illustrate cross-sectional views of wireless earbuds according to embodiments of the present disclosure; and

FIGS. 7A to 7B schematically illustrate a comparison between the performance of a wireless earbud using a part of housing as an antenna component and the performance of a conventional wireless earbud, wherein curves in FIG. 7A are obtained when earbuds work in a user's ears, and curves in FIG. 7B are obtained when earbuds work with a hand touching the housing of the earbuds.

### DETAILED DESCRIPTION

Hereinafter, various embodiments of the present disclosure are described with reference to the accompanying drawings. However, it should be understood that there is no intent to limit the present disclosure to the particular forms disclosed herein; rather, the present disclosure is intended to be construed to cover various modifications, equivalents, and/or alternatives of embodiments of the present disclosure. In describing the drawings, similar reference numerals may be used to designate similar elements.

As used herein, the expressions “have”, “may have”, “include”, and “may include” refer to the existence of a corresponding feature (e.g., a numeral, a function, an operation, or an element such as a component), but does not exclude one or more additional features.

The expressions “a first”, “a second”, “the first”, and “the second” used in various embodiments of the present disclosure may modify various components regardless of order and/or importance but is not intended to limit the corresponding components. For example, a first device and a second device indicate different devices although both of them are devices. For example, a first element may be referred to as a second element, and similarly, a second element may be referred to as a first element without departing from the scope of the present disclosure.

It should be understood that when an element (e.g., a first element) is referred to as being (operatively or communicatively) “connected,” or “coupled,” to another element (e.g., a second element), the element may be directly connected or coupled directly to the other element or any other element (e.g., a third element) may be interposer between them. In contrast, it may be understood that when an element (e.g., a first element) is referred to as being “directly connected,” or “directly coupled” to another element (e.g., a second element), there is no element (e.g., a third element) interposed between them.

The present disclosure provides an antenna for a wireless earbud having a metal plate and a wireless earbud including the antenna, wherein the metal plate is used as a radiator of an antenna of the wireless earbud.

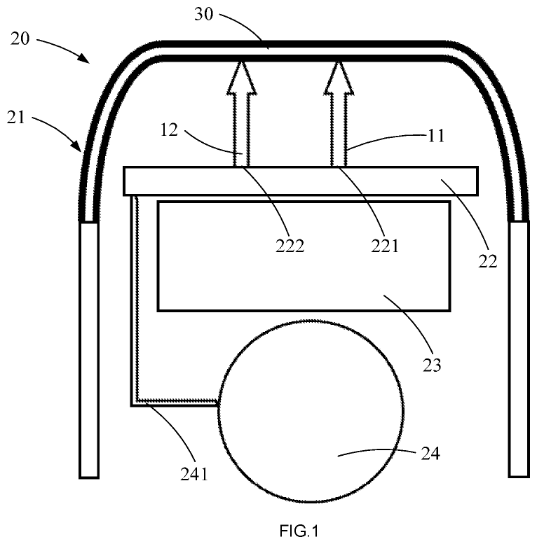

FIG. 1 schematically illustrates a cross-sectional view of an internal structure of a wireless earbud 20 according to an embodiment of the present disclosure. As shown in FIG. 1, the wireless earbud 20 includes a housing 21, a PCB 22, a battery 23 for providing voltage source and a speaker 24 accommodated in the housing 21. The PCB 22 is configured with a feeding terminal 221 and a grounding terminal 222. The feeding terminal 221 is configured to feed RF signals obtained from an antenna of the wireless earbud 20 to subsequent circuits or transmit signals from subsequent circuits to the antenna of the wireless earbud. The speaker 24 is connected with the PCB 22 through an FPC (flexible printed circuit) 241 or other connecting structure.

In an embodiment of the present disclosure, at least a part of the housing 21 is made of conductive material, such as a metal plate. The part of the housing made of conductive material constitutes an antenna component 30 to act as an antenna radiator of the antenna of the wireless earbud 20. The antenna component 30 is electrically coupled to the feeding terminal 221 and electrically coupled to the grounding terminal 222 configured on the PCB 22. The antenna component 30 may be directly electrically coupled to the grounding terminal 222, or may be indirectly electrically coupled to the grounding terminal 222.

In some embodiment, the antenna component 30 may be made of aluminum or stainless steel. In some embodiment, the antenna component 30 takes a shape of a flat plate or a curved plate.

In some embodiment, the antenna component 30 has a symmetrical structure relative to a center of the antenna component. For example, the antenna component has a circular structure, in order to improve radiation performance of the antenna.

In some embodiment, there may be configured on the PCB 22 contact components for electrical connection. Referring to FIG. 1, a first contact component 11 is configured to be electrically coupled between the antenna component 30 and the feeding terminal 221, and a second contact component 12 is configured to be electrically coupled between the antenna component 30 and the grounding terminal 222. In some embodiment, the first contact component 11 and the second contact component 12 may be a pogo-pin or a leaf spring. The first contact component 11 and the second contact component 12 may be arranged perpendicularly to the PCB 22.

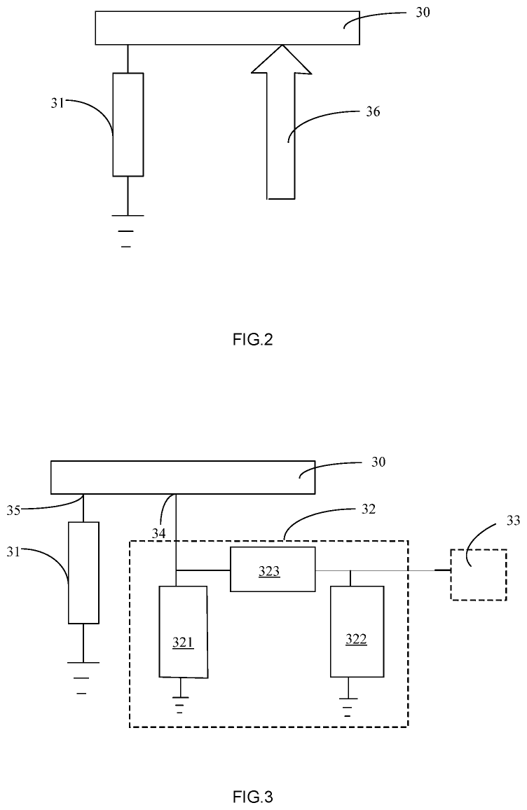

In some embodiment, the wireless earbud 20 may further include a protection circuit configured to be electrically coupled between the antenna component 30 and the grounding terminal 222 on the PCB 22. FIG. 2 schematically illustrates an equivalent circuit diagram of an antenna of the wireless earbud. As shown in FIG. 2, a protection circuit 31 is configured between the antenna component 30 and the grounding terminal configured on the PCB. The protection circuit 31 can make most of current of ESD (Electro-Static discharge) go to the grounding terminal. In this situation, the protection circuit 31 is coupled to the grounding terminal on the PCB through wires, and the antenna component 30 is electrically coupled to the feeding terminal through a sole contact component 36. In some embodiment, the sole contact component 36 may be a pogo-pin or a leaf spring. The sole contact component 36 may be arranged perpendicularly to the PCB 22.

In some embodiment, a matching circuit may be further configured in the housing for boosting the performance of the antenna. The matching circuit may be electrically configured between the antenna component and the feeding terminal of a RF module.

FIG. 3 schematically illustrates an equivalent circuit diagram of an antenna of the wireless earbud according to another embodiment of the present disclosure. The antenna includes the antenna component 30 and the protection circuit 31. In some embodiment, the antenna component 30 is at least a part of the housing of the wireless earbud. The antenna component 30 is made of a metal plate. There is also configured a matching circuit 32 in the housing between the antenna component 30 and a feeding terminal of a RF module 33 on the PCB to improve the antenna performance.

In some embodiment, the antenna component 30 may be configured with contact points thereon for electronical contact. The contact points may protrude the inner surface of the antenna component 30, or flush with the inner surface of the antenna component 30. As shown in FIG. 3, the antenna component 30 is electrically coupled to the matching circuit 32 on the PCB through a first contact point 34, and the protection circuit 31 is electrically coupled to the antenna component 30 through a second contact point 35.

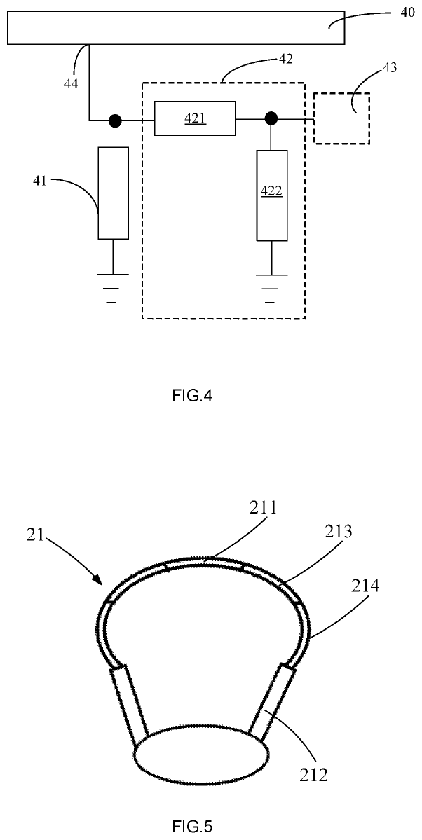

FIG. 4 schematically illustrates an equivalent circuit diagram of an antenna of the wireless earbud according to yet another embodiment of the present disclosure. As shown in FIG. 4, the antenna includes an antenna component 40, a protection circuit 41 and a matching circuit 42. The protection circuit 41 is configured to be electrically coupled between the antenna component 40 and the grounding terminal on the PCB. The matching circuit 42 is configured to be electrically coupled between the antenna component 40 and a feeding terminal of a RF module 43 on the PCB. The antenna component 40 is at least a part of the housing of the wireless earbud. The matching circuit 42 is electrically coupled to one end of the protection circuit 41 and then the end of the protection circuit 41 is electrically coupled to the antenna component 40 through one contact point 44 configured on the antenna component 40.

In some embodiment, the protection circuit 31 or 41 may include a passive element, for example, an inductor or a resistor. In some embodiment, the protection circuit 31 or 41 includes an inductor having an inductor value ranging from 0.1 nH to 200 nH. The matching circuit 32 or 42 may adjust the matching impedance of the antenna to obtain an optimal antenna gain and to adjust the resonance frequency of the antenna. In some embodiment, the matching circuit 32 or 42 may include passive elements. In some embodiment, the matching circuit 32 or 42 may include a resistor, a capacitor and/or an inductor.

As shown in FIG. 3, the matching circuit 32 includes a first passive element 321, a second passive element 322 and a third passive element 323. The first passive element 321 and the second passive element 322 may be an inductor or a capacitor. The third passive element 323 may be an inductor, a capacitor or a resistor. The resistor may have a resistance value of 0 ohm. In some embodiment, the first passive element 321 and the second passive element 322 may be omitted. That is, the matching circuit 32 only includes the third passive element 323 disposed between the antenna component 30 and the feeding terminal of the RF module 33.

As shown in FIG. 4, the matching circuit 42 includes a first passive element 421 and a second passive element 422. The first passive element 421 may be an inductor, a capacitor or a resistor. The resistor may have a resistance value of 0 ohm. The second passive element 422 may be an inductor or a capacitor. In some embodiment, the second passive element 422 may be omitted. That is, the matching circuit 42 only includes the first passive element 421.

In practical application, the housing of an earbud may include several separated parts. FIG. 5 schematically illustrates a structure of the housing 21 of the earbud 20. As shown in FIG. 5, the housing 21 includes a top part 211 farthest to a user in use, namely, a center part of the housing, an in-ear part 212 surrounding a sound outlet of the earbud, and a middle part between the top part 211 and the in-ear part 212. The middle part includes a first ring-shaped part 213 and a second ring-shaped part 214 connected in sequence. In some embodiment, the in-ear part 212 may be made of plastic for comfort. In some embodiment, the in-ear part 212 is made of ABS, or silica gel.

In some embodiment, the PCB 22 may be disposed close to the top part 211, and the battery 23 and the speaker 24 may be disposed close to the in-ear part 212. When a user wears the wireless earbud, the plane of the top part 211 is substantially parallel to one side of the user's head.

In some embodiment, at least one part among the top part 211, the first ring-shaped part 213, and the second ring-shaped part 214 is made of conductive material to constitute the antenna component 30 to act as the antenna radiator of the wireless earbud. The other part among the top part 211, the first ring-shaped part 213 and the second ring-shaped part 214 which do not constitute the antenna component may be made of conductive material or non-conductive material. However, if a part of the housing is made of conductive material but does not constitute an antenna component, it should be isolated from the antenna component if they are disposed adjacently.

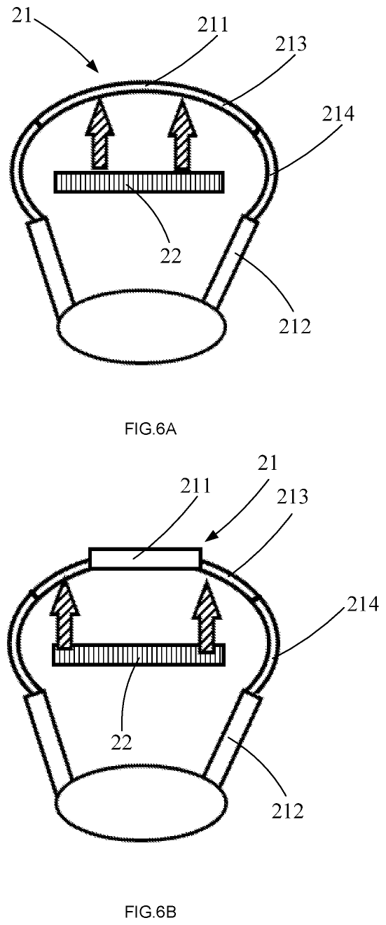

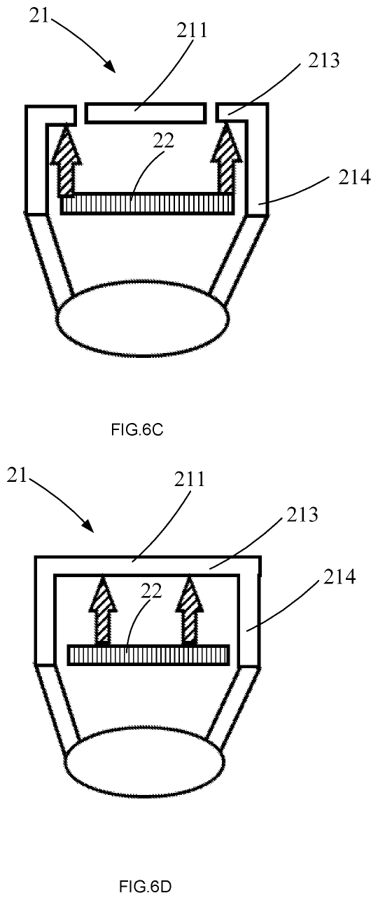

FIGS. 6A to 6D schematically illustrate cross-sectional views of the wireless earbuds according to embodiments of the present disclosure. As shown in FIG. 6A, the top part 211 and the first ring-shaped part 213 of the housing 21 of the wireless earbud 20 are integrally formed with each other, and are made of conductive material to form the antenna component.

As shown in FIG. 6B, the top part 211 is made of plastic, and the first ring-shaped part 213 is made of conductive material to form the antenna component30.

As shown in FIG. 6C, all of the top part 211, the first ring-shaped part 213 and second ring-shaped part 214 are made of conductive material. The first ring-shaped part 213 is not directly connected to the top part 211, and an isolation part is formed between them. The isolation part may have a size from 0.05 mm to 3 mm. The first ring-shaped part 213 and a second ring-shaped part 214, which are integrally formed, form the antenna component.

As shown in FIG. 6D, all of the top part 211, the first ring-shaped part 213 and second ring-shaped part 214 are made of conductive material, and all of them form the antenna component together. In some embodiment, the top part 211, the first ring-shaped part 213 and second ring-shaped part 214 are integrally formed.

As shown in FIGS. 6A to 6D, the PCB 22 and the in-ear part 212 are configured similarly to FIG. 1 and thus are not described in detail hereinafter.

FIGS. 6A to 6D are merely for exemplary illustration. There may be other configurations for the antenna component, which are not enumerated one by one hereinafter. And the protection scope should not be limited by the examples as described above.

As is known in RF field, antenna's resonance frequency is greatly affected by metal size. Inventors find the size of the housing is an optimal size for RF application with frequency over 1.5 GHz like LTE/3G/GSM, Bluetooth, WiFi, GPS and so on. Currently, for instance, the bluetooth earbud works at 2.4 GHz, which can be obtained by configuration of the housing of the earbud. Further, the resonance frequency can be slightly adjusted by adjusting the matching circuit. In this way, contact points and additional antenna radiator used in conventional wireless earbuds can be reduced or even omitted, which greatly decrease the cost of wireless earbuds. Further, the performance of the antenna can be maintained as the conventional one or even better.

The present disclosure also provides an electronic device. The electronic device includes a housing and a PCB accommodated in the housing. The housing includes a sole metal plate. The sole metal plate constitutes an antenna component to act as an antenna radiator of the electronic device. The PCB is provided with a grounding terminal and a feeding terminal thereon. The antenna component is electrically coupled to the feeding terminal on the PCB, and the antenna component is electrically coupled to the grounding terminal on the PCB directly or indirectly.

In some embodiments, the housing of the electronic device may further include other metal plates which are not used as the antenna component. However, in this situation, these other metal plates which are not used as the antenna component should be isolated from the sole metal plate which constitutes the antenna component. In some embodiment, the electronic device may be an earbud, a finger ring, a finger cap, an ear nail and the like.

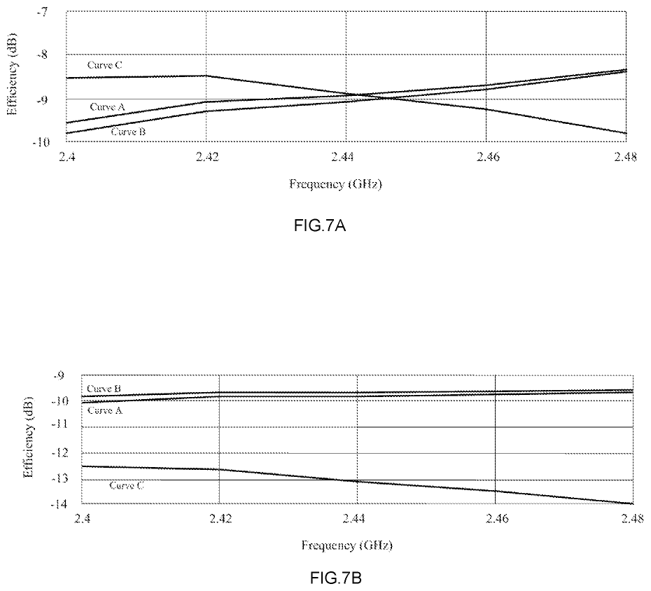

FIGS. 7A and 7B schematically illustrate a comparison between the performance of a wireless earbud using a part of housing as the antenna component and the performance of a conventional wireless earbud using plastic as the housing. A horizontal coordinate represents Bluetooth frequency in GHz, and a perpendicular coordinate represents gain of efficiency in dB. Curve A represents antenna performance of a wireless earbud with the top part of the housing as the antenna component, wherein the top part is made of metal. Curve B represents antenna performance of a wireless earbud with the first ring-shaped part as the antenna component, wherein the top part is made of plastic. Curve C represents antenna performance of a conventional earbud using a plastic chassis as the housing of the earbud. It can be seen that the performance of the wireless earbud according to the present disclosure is almost same as plastic chassis earbuds.

Curves in FIG. 7A are obtained when earbuds work in a user's ears, and curves in FIG. 7B are obtained when earbuds work with a hand touching the housing of the earbuds. It can be seen earbuds with a part of housing as antenna component are immune to touch of a hand and have a quite good and stable performance comparing with the plastic chassis earbuds.

The terms used herein are merely for the purpose of describing certain embodiments of the present disclosure and are not intended to limit the scope of other embodiments. A singular expression may include a plural expression unless they are definitely different in a context. Unless defined otherwise, all terms used herein, have the same meanings as those commonly understood by a person skilled in the art to which the present disclosure pertains. Such terms as those defined in a generally used dictionary may be interpreted to have meanings equal to the contextual meanings in the relevant field of art, and are not intended to be interpreted to have ideal or excessively formal meanings unless clearly defined in the present disclosure. In some cases, even a term defined in the present disclosure should not be interpreted to exclude embodiments of the present disclosure.

Various embodiments disclosed herein are provided merely to easily describe technical details of the present disclosure and to help the understanding of the present disclosure, and are not intended to limit the scope of the present disclosure. Accordingly, it is intended that the present disclosure include all modifications or various other embodiments within the scope of the present disclosure, as defined by the appended claims and their equivalents.

1. An antenna, comprising:
a metal plate;
wherein the metal plate is at least a part of a housing of an earbud, the metal plate is configured to be electrically coupled to a feeding terminal and a grounding terminal on a PCB, and the PCB is accommodated in the earbud.

2. The antenna according to claim 1, further comprising:
a protection circuit, configured to be electrically coupled between the metal plate and the grounding terminal on the PCB; and
a sole contact component, configured to be electrically coupled between the metal plate and the feeding terminal on the PCB.

3. The antenna according to claim 2, wherein the protection circuit is an inductor or a resistor.

4. The antenna according to claim 1, further comprising:
a first contact component, configured to be electrically coupled between the metal plate and the feeding terminal; and
a second contact component, configured to be electrically coupled between the metal plate and the grounding terminal.

5. The antenna according to claim 4, wherein the first contact component and/or the second contact component is a pogo-pin or a leaf spring.

6. The antenna according to claim 1, further comprising:
a protection circuit, configured to be electrically coupled between the metal plate and the grounding terminal on the PCB; and
a matching circuit, configured to be electrically coupled between the metal plate and the feeding terminal on the PCB,
wherein the matching circuit and the protection circuit are electrically coupled to the metal plate through one contact point configured on the metal plate, or the matching circuit and the protection circuit are electrically coupled to the metal plate through two contact points configured on the metal plate respectively.

7. The antenna according to claim 6, wherein the matching circuit comprises an inductor, a capacitor and/or a resistor.

8. The antenna according to claim 1, wherein the metal plate is made of aluminum or stainless steel.

9. (canceled)

10. The antenna according to claim 1, wherein the metal plate has a symmetrical structure relative to a center of the metal plate.

11. A wireless earbud, comprising:
a housing; and
a PCB, accommodated in the housing and provided with a grounding terminal and a feeding terminal thereon;
wherein a part of the housing constitutes an antenna component to act as an antenna radiator of the wireless earbud, the antenna component is electrically coupled to the feeding terminal on the PCB, and the antenna component is electrically coupled to the grounding terminal on the PCB.

12. The wireless earbud according to claim 11, further comprising:
a protection circuit, configured to be electrically coupled between the antenna component and the grounding terminal on the PCB; and
a sole contact component, configured to be electrically coupled between the antenna component and the feeding terminal on the PCB.

13. The wireless earbud according to claim 12, wherein the protection circuit is an inductor or a resistor.

14. The wireless earbud according to claim 11, further comprising:
a first contact component, configured to be electrically coupled between the antenna component and the feeding terminal; and
a second contact component, configured to be electrically coupled between the antenna component and the grounding terminal.

15. The wireless earbud according to claim 14, wherein the first contact component and/or the second contact component is a pogo-pin or a leaf spring.

16. The wireless earbud according to claim 11, further comprising:
a protection circuit, configured to be electrically coupled between the antenna component and the grounding terminal on the PCB; and
a matching circuit, configured to be electrically coupled between the antenna component and the feeding terminal on the PCB;
wherein the matching circuit and the protection circuit are electrically coupled to the antenna component through one contact point configured on the antenna component, or the matching circuit and the protection circuit are electrically coupled to the antenna component through two contact points configured on the antenna component respectively.

17. The wireless earbud according to claim 16, wherein the matching circuit comprises an inductor, a capacitor or a resistor.

18. The wireless earbud according to claim 11,
wherein the housing comprises a top part farthest to a user in use and an in-ear part, and a first ring-shaped part and a second ring-shaped part connected in sequence between the top part and the in-ear part;
wherein at least one of the top part, the first ring-shaped part and the second ring-shaped part constitutes the antenna component.

19. The wireless earbud according to claim 18, wherein the first ring-shaped part and/or the second ring-shaped part constitutes the antenna component, and the top part is made of a conductive material or plastic and is isolated from the antenna component.

20. The wireless earbud according to claim 11, wherein the antenna component is made of aluminum or stainless steel.

21. An electronic device, comprising:
a housing; and
a PCB, accommodated in the housing and provided with a grounding terminal and a feeding terminal thereon;
wherein the housing comprises a sole metal plate, the sole metal plate constitutes an antenna component to act as an antenna radiator of the electronic device, the antenna component is electrically coupled to the feeding terminal on the PCB, and the antenna component is electrically coupled to the grounding terminal on the PCB.
